(19) United States
(12) Patent Application Publication
(10) Pub. No.: US 2024/0241764 A1
(43) Pub. Date: Jul. 18, 2024

(54) AUTOMATED SYSTEM FOR COLLECTING, STORING, SEARCHING, AND CORRELATING METRICS, LOG MESSAGES AND TRACES OF A DISTRIBUTED APPLICATION

(71) Applicant: VMWARE, INC., Palo Alto, CA (US)

(72) Inventors: Chandrashekhar Jha, Bangalore (IN); Akash Srivastava, Bangalore (IN); Saloni Shah, Bangalore (IN); Chaitanya Krishna Mullangi, Bangalore (IN); Siddartha Laxman Karibhimanvar, Bangalore (IN)

(21) Appl. No.: 18/128,236

(22) Filed: Mar. 30, 2023

(30) Foreign Application Priority Data
Jan. 16, 2023 (IN) 202341003136

(51) Int. Cl. G06F 9/50

(52) U.S. Cl. CPC G06F 9/5072

(57) ABSTRACT

The present disclosure relates to a system for monitoring execution of a distributed application running in a data center. The system includes a forwarder that runs in a tenant environment of the data center. The forwarder collects metrics, log messages, and spans output from microservices of the distributed application. The system includes an ingestion engine that receives the metrics, the log messages, and the spans output from the forwarder. The ingestion engine forms a trace from the spans, and stores the metrics, the log messages, and the trace with a common identifier in a database. The includes a user interface (“UT”) that displays the metrics, the log messages, and the trace in response to a user selection to the metrics, the log messages, and the trace via the UI.

### TECHNICAL FIELD

This disclosure is directed to managing distributed applications executing a distributed computing environment.

### BACKGROUND

Electronic computing has evolved from primitive, vacuum-tube-based computer systems to modern electronic computing systems in which large numbers of multi-processor computer systems are networked together with large-capacity data-storage devices and other electronic devices in data centers that provide enormous computational bandwidths and data-storage capacities. Data centers are made possible by advances in virtualization, computer networking, distributed operating systems, data-storage appliances, computer hardware, and software technologies. An increasing number of businesses, governments, and other organizations rent data processing services and data storage space as data center tenants. Data center tenants now conduct business and provide cloud services over the internet on software platforms that are maintained and run almost entirely in data centers, which reduces the cost of maintaining their own centralized computing networks and hosts.

Cloud services were historically provided by monolithic applications running in data centers. A monolithic application is single-tiered software in which the user interface, data processing, and data access code are implemented in a single program that is run on a single platform. Each monolithic application is self-contained and runs independent from other applications. The design philosophy was that a monolithic application performs every step needed to complete a particular function or service requested by a client. However, monolithic applications have several disadvantages. Individual components of a monolithic application cannot be changed. Any changes in the framework or language of a monolithic application often affects the entire application, which is expensive and time-consuming. A small change to a monolithic application requires redeployment of the full application.

In recent years, the software landscape has evolved away from monolithic applications to distributed applications with independent application components, called microservices. The distributed application runs in a microservices architecture composed of independently deployable microservices. Each microservice has its own logic and database and performs a single function or provides a single service. For example, streaming services that offer films and shows over the internet are run in a microservices architecture. A typical streaming service may have thousands of microservices that provide a seamless viewing experience to users. The microservices architecture has several advantages over a monolithic application. The microservices of the microservices architecture run independently. Each microservice can be separately developed, updated, deployed, and scaled up or down without affecting the other microservices. Software updates can be performed more frequently, with improved reliability, uptime, and performance.

Monolithic applications and distributed applications can both experience performance problems. However, troubleshooting these performance problems is often very different. When performance problems arise in monolithic applications, troubleshooting is typically a manageable process because the application is based on a single code. Developers read log messages that record information about the state of an operating system, state of a service, or state of computer hardware at points in time to identify the source of the problem. On the other hand, troubleshooting distributed applications is considerably more challenging and time consuming. Each microservice generates a separate file of log messages. As a result, typical distributed applications can generate millions of log messages each day. Troubleshooting a performance problem with a distributed application often requires teams of developers and software engineers with the aid of automated log analytics services to determine root causes of hardware and software performance problems. However, this process can be prohibitively expensive because of the large volumes of log messages that must be stored and processed. As a result, troubleshooting a performance problem can take days and, in some cases, longer. Long delays in troubleshooting a performance problem can perpetuate mistakes in processing transactions or denying people access to services provided by an organization, which damages an organizations reputation and drives customers to competitors.

### SUMMARY

The present disclosure relates to system for collecting, storing, searching, and correlating metrics, log messages, and traces of a distributed application running in a data center. The system includes a forwarder that collects metrics, log messages, and spans output from microservices of the distributed application for a user request received by the distributed application. The includes an ingestion engine that receives the metrics, the log messages, and the spans output from the forwarder. The ingestion engine forms a trace from the spans and stores the metrics, the log messages, and the trace with common identifier in a database. The system displays an interactive user interface (“UI”) in a display device. The UI displays the metrics, the log messages, and the trace in response to a user selection of the user request via the UI. The UI enables users to identify failures in various user requests of the application. The trace is displayed in the form of a waterfall model which contains the time taken by each span, which aids users in debugging application slowness and understanding the request flow in real time.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machine (“VM”) and VM execution environments.

FIG. 6 shows an example of an open virtualization format package.

FIG. 7 shows example virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer located above a physical data center.

FIG. 14 shows an example microservices architectural of a distributed application composed of eight microservices.

FIG. 15 shows microservices of the distributed application shown FIG. 14 with open telemetry (“OTL”) libraries and OTL agents.

FIG. 16 shows a plot of an example metric.

FIG. 17 shows an example of logging log messages in log files.

FIG. 18 shows an example source code of an event source that generates log messages.

FIG. 19 shows an example of a log write instruction.

FIG. 20 shows an example of a log message generated by the log write instruction.

FIG. 21 shows an eight-entry portion of a log file.

FIGS. 22A-22B show an example of metrics, log messages, and a span collected by an OTL library of a microservice of a distributed application.

FIG. 23A shows an example of metrics, log messages, and spans received by a forwarder from the OTL agents of microservices of a distributed application.

FIG. 23B shows an example trace formed from spans in the table of FIG. 23A.

FIG. 24 shows an example architecture of an operations manager.

FIGS. 25A-25B show an example UI that enables a user to display metrics, log messages, and a trace associated with each user request of the distributed application and display structure data of microservices.

### DETAILED DESCRIPTION

This disclosure presents automated computer-implemented systems for collecting, storing, searching, and correlating metrics, log messages, and traces of a distributed application running in a data center. In a first subsection, computer hardware, complex computational systems, and virtualization are described. Automated systems for collecting, storing, searching, and correlating metrics, log messages, and traces of a distributed application running in a data center are described below in a second subsection.

### Computer Hardware, Complex Computational Systems, and Virtualization

The term “abstraction” as used to describe virtualization below is not intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces.

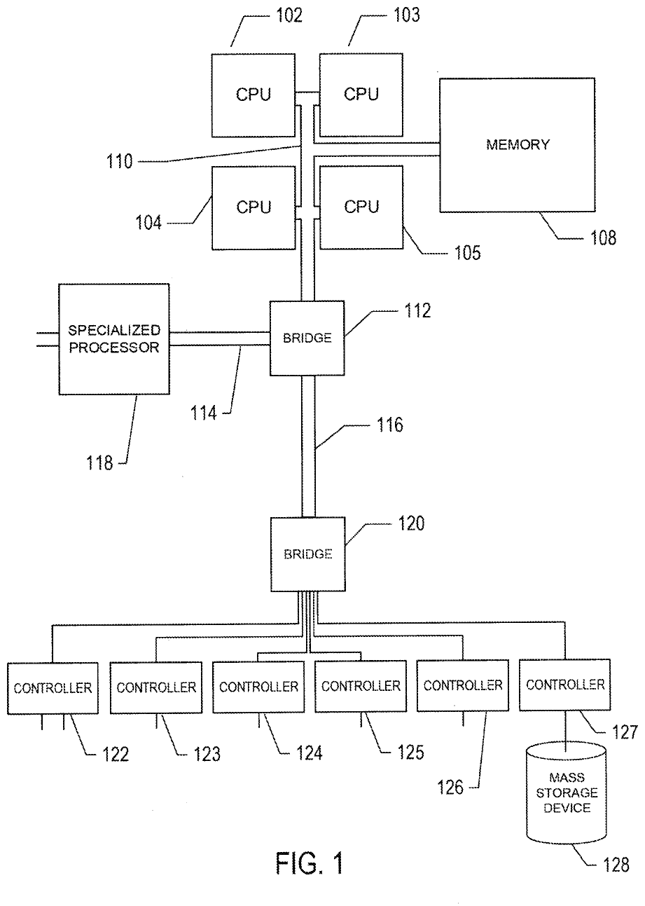

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

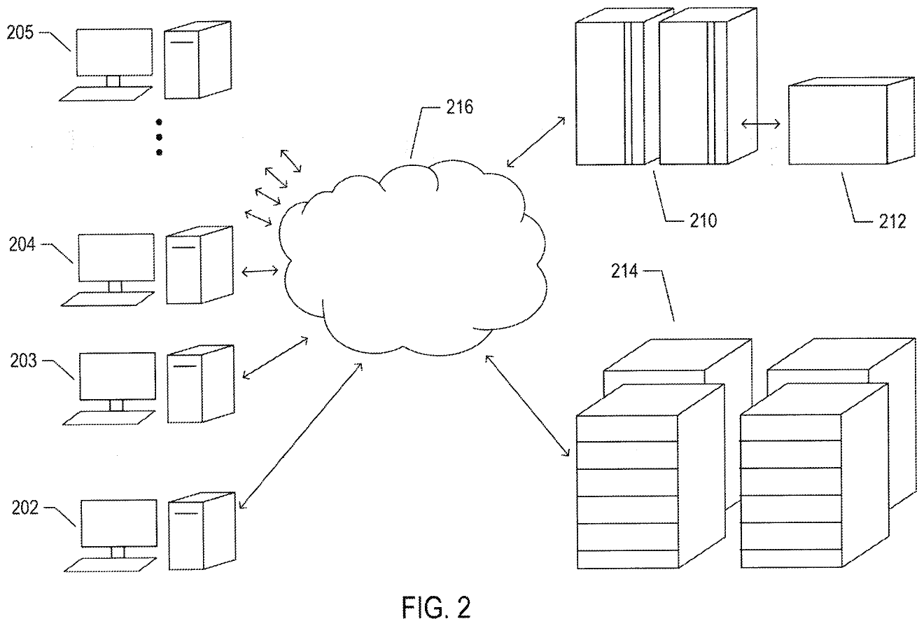

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

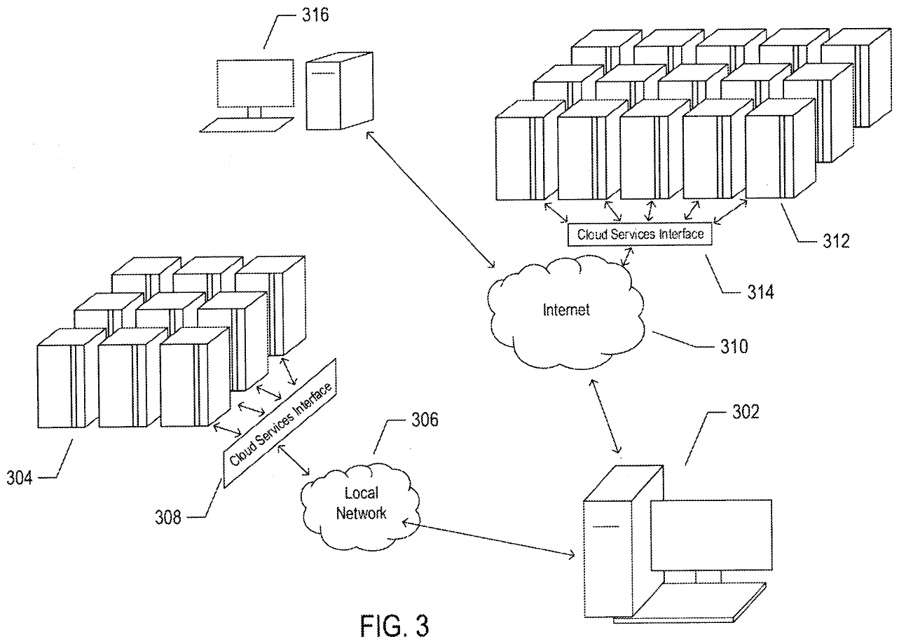

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

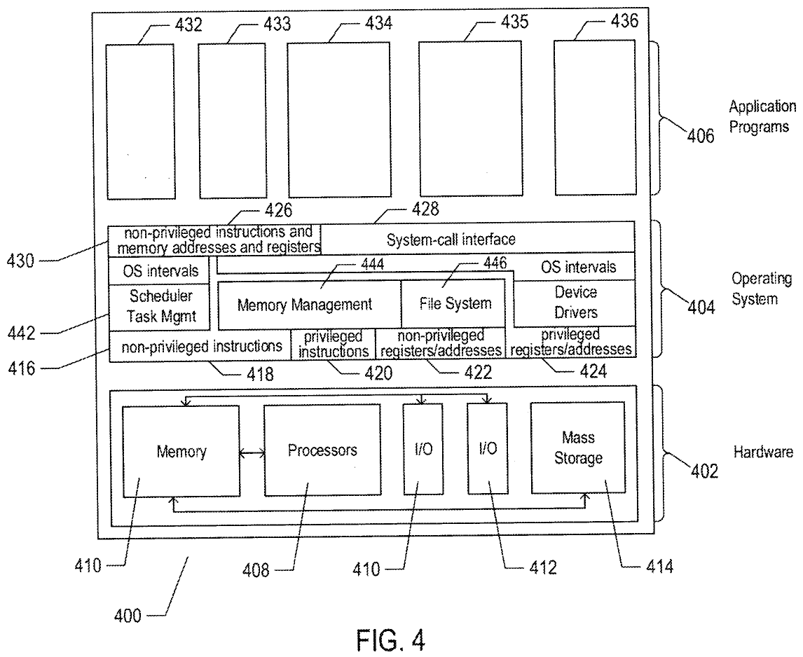

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410. various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

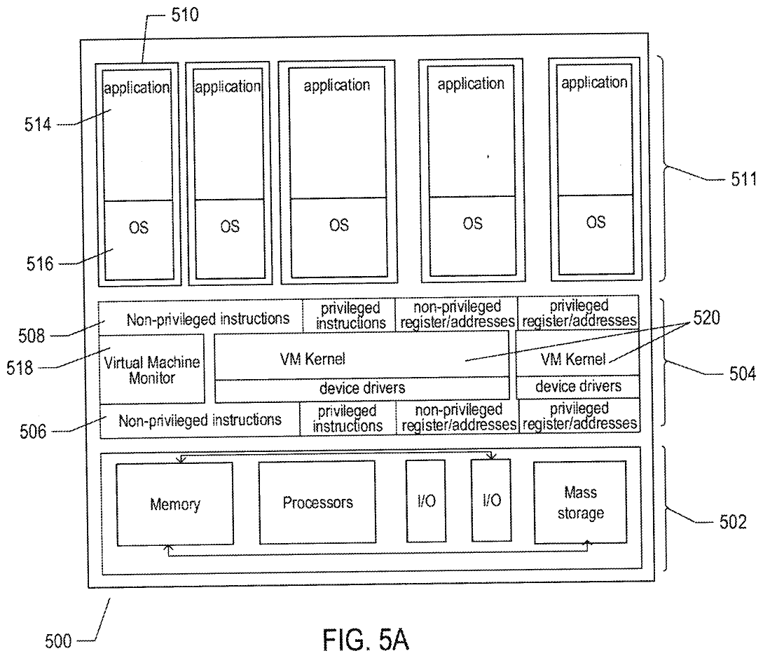

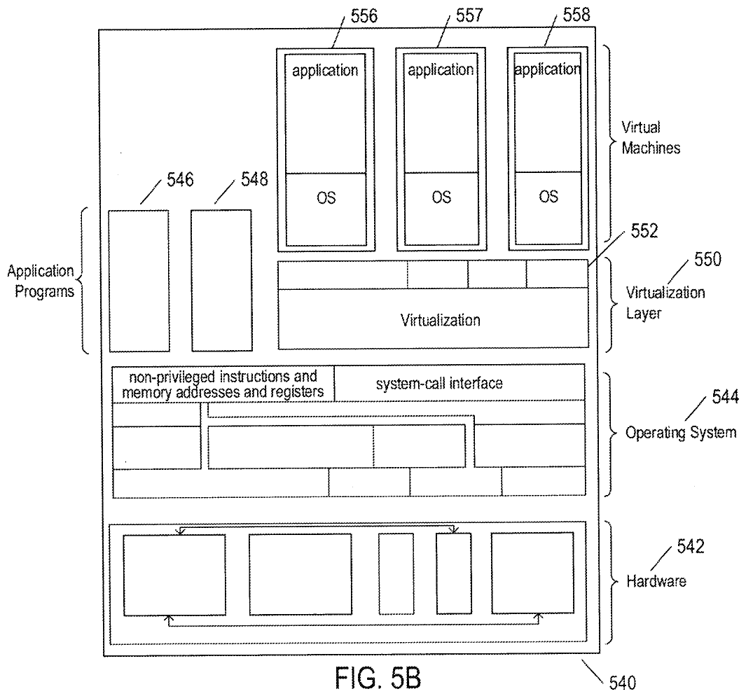

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

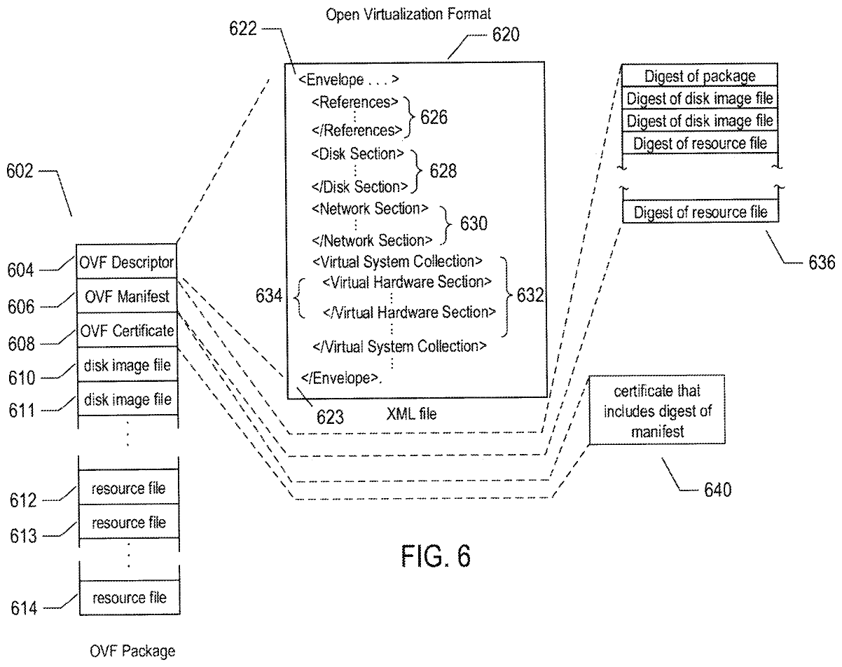

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

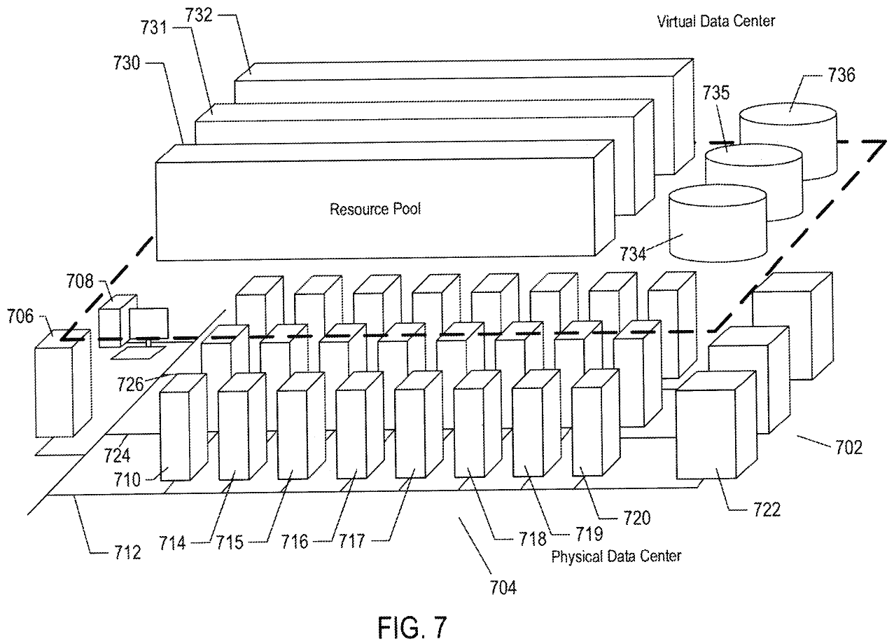

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

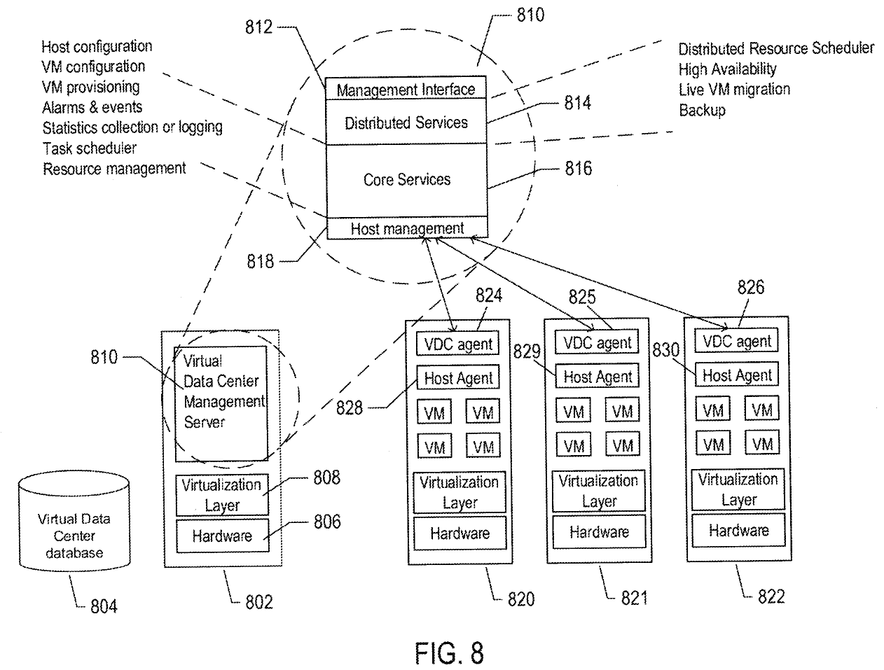

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenat.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

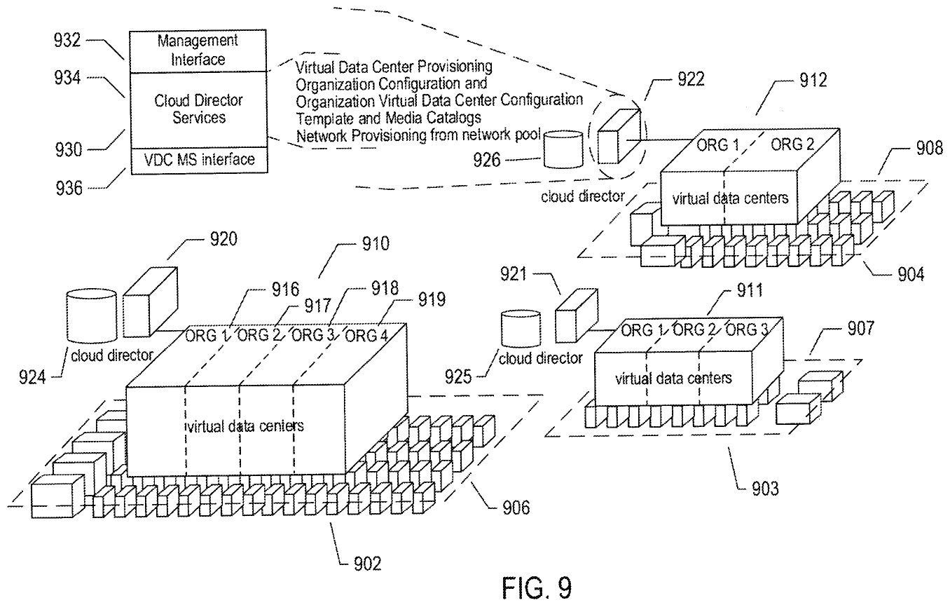

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

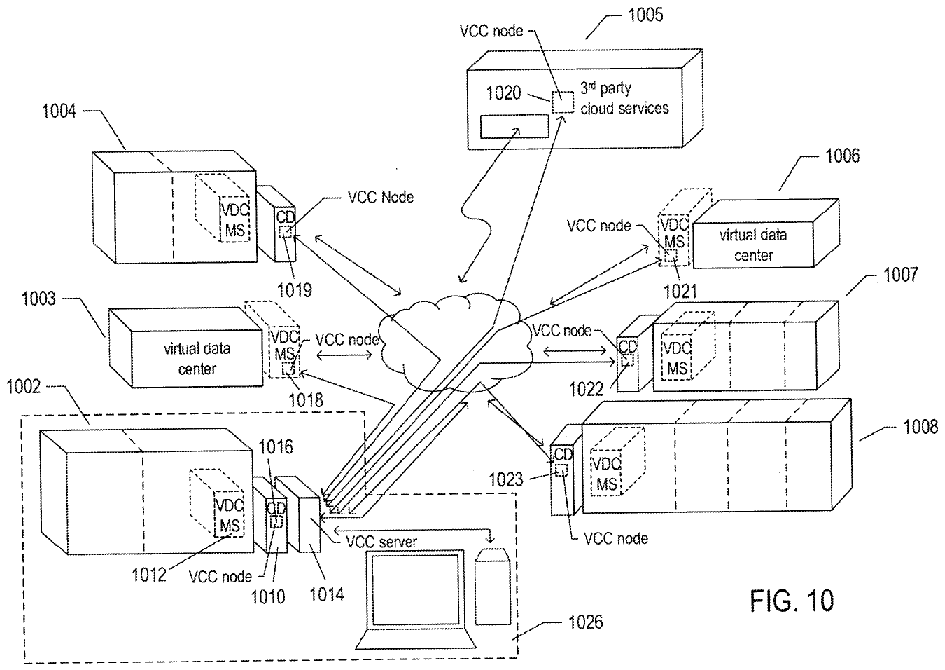

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally Interfaces, through the Internet, to VCC node virtual appliances executing within remote VDC management servers, remote cloud directors, or within the third-party cloud services 1018-1023. The VCC server provides a VCC server interface that can be displayed on a local or remote terminal. PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies

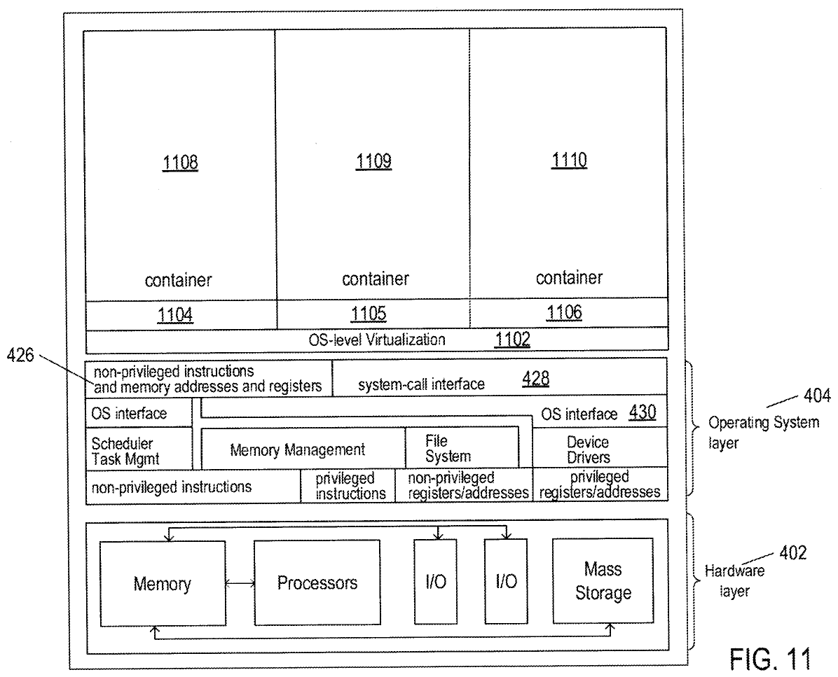

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404. OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

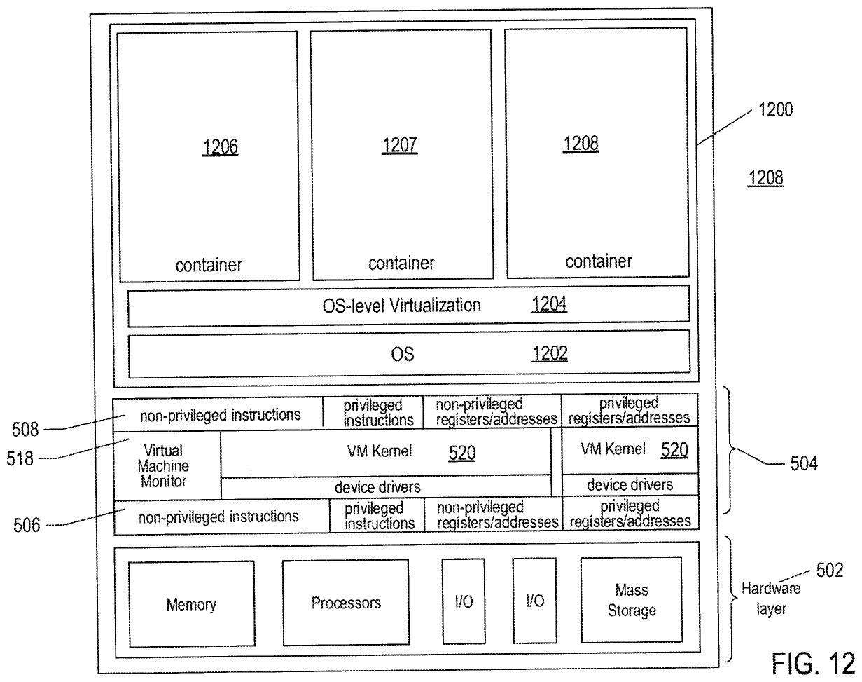

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL- virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Automated Methods and Systems for Collecting, Storing, Searching, and Correlating Metrics, Log Messages, and Traces of a Distributed Application

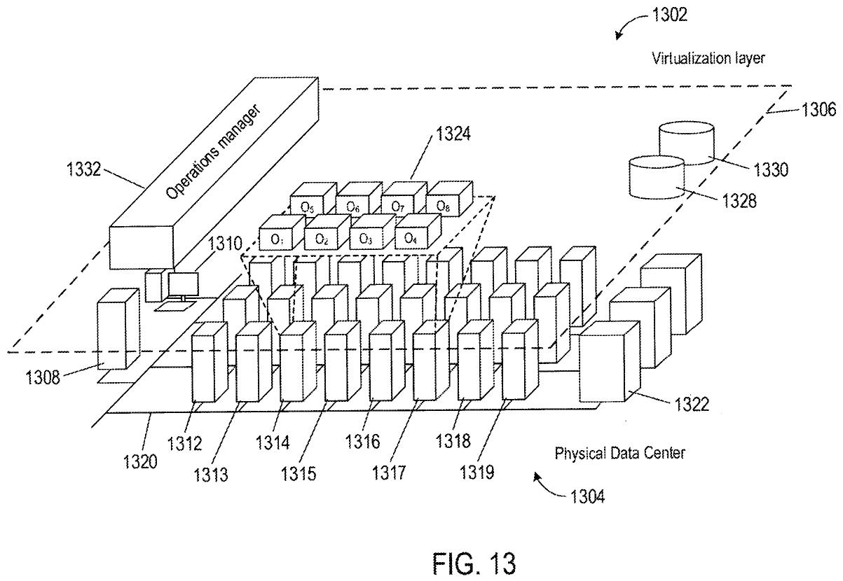

FIG. 13 shows an example of a virtualization layer 1302 located above a physical data center 1304. For the sake of illustration, the virtualization layer 1302 is show separate from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual-data-center (“VDC”) management interface may be displayed to system administrators and other users, server computers, such as server computers 1312-1319, data-storage devices, and network devices. Each server computer may have multiple network interface cards (“NICs”) to provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems, and devices connected according to many different types of connection topologies.

The virtual-interface plane 1306 abstracts the resources of the physical data center 1304 to one or more VDCs comprising the virtual objects and one or more virtual data stores, such as virtual data stores 1328 and 1330. A virtual object can be a VM, application component, or a container hosted by a server computer in the physical data center 1304. The virtualization layer 1302 may also include a virtual network (not illustrated) of virtual switches, routers, load balancers, and NICs. In this example, the virtualization layer 1302 runs a distributed application in a VDC composed of virtual objects denoted by O₁, O₂, O₃, O₄, O₅, O₆, O₇, and O₈ that run on server computers 1314-1317 and virtual data stores 1328 and 1330. Each virtual object may run a different microservice of the distributed application.

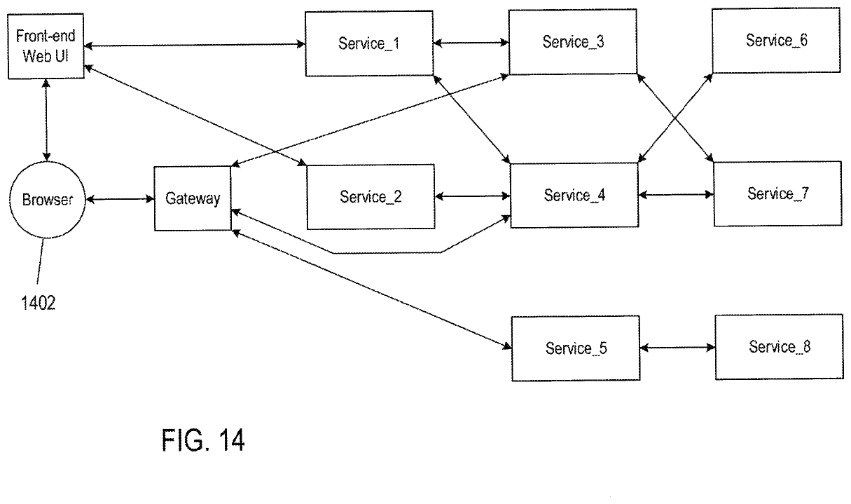

FIG. 14 shows an example microservices architectural of a distributed application composed of eight microservices. A user may access the distributed application via a browser 1402, such as Google Chrome, Firebox, Apple Safari, or Microsoft Edge, running on a computing device, such as desktop computer, laptop computer, or mobile device. The microservices are represented by blocks identified as Service_n, where index n=1, . . . , 8. The application includes a front-end web user interface (“UI”) 1404 and a gateway 1406. The front-end UI 1404 displays the fields, buttons, and windows of the microservices Service_1 and Service_2 a user interacts with when visiting the website of the distributed application. The gateway 1406 connects the browser 1402 to microservices Service_3, Service_4, and Service_5. The microservices can be run in separate virtual objects, such as the eight virtual objects O₁, O₂, O₃, O₄, O₅, O₆, O₇, and O₈ of FIG. 13. The microservices are interconnected and depend on instructions or information produced by other microservices. Directional arrows represent interconnects between microservices for sending and receiving instructions and data. In this example, customers access a vendor's website via the web browser 1402 to submit a user request. The front-end web UI 1404 enables users to access microservices Service_1 and Service_2 via the browser 1402. For example, microservice Service_1 may be a customer web UI that enables a customer to view and purchase goods or services offered by the vendor over the internet. Microservice Service_2 may be another web UI that enables the vendor to display goods or services for sale to customers over the internet. The other microservices Service_3, Service_4, Service_5, Service_6, Service_7, and Service_8 execute backend services that complete transactions between customers and the vendor. For example, microservice Service_4 directs operations performed by microservices Service_6 and Service_7. Microservice Service_6 generates notifications that are sent to customers and the vendor during a transaction. Microservice Service_7 completes the transfer of funds from the user's bank to the vendor's bank when transactions are confirmed by the user.

Distributed applications, in general, provide advantages over monolithic applications. A monolithic application is implemented as a single program in which the user interface, data processing, and data access code are run on a single platform. For example, all the services of a monolithic shopping application, such as displaying merchandise, payment, and inventory, are implemented in a single program. By contrast, with a distributed application, the services are performed by separate microservices (i.e., separate application components). Individual microservices can be scaled up or down depending on demand for a microservice. For example, in FIG. 14, during a sales event certain microservices running in the data center are increased in number to satisfy an increased number of customers purchasing goods or services from the vendor. Alternatively, when the sales event is over, each of these microservices is decreased in number to avoid idle virtual objects. Individual components of a monolithic application cannot be scaled in the same manner. Each of the microservices can also be separately upgraded to an up-to-date version without affecting the other microservices. For example, microservice Service_7 in FIG. 14 can be upgraded to handled changes to the vendor's banking procedures. By contrast, any changes in the framework of a monolithic application affects the entire application, making such changes are often expensive and time-consuming. Any change to a monolithic application requires redeployment of the entire application.

Although distributed applications offer deployment, upgrade, and scaling advantages over monolithic applications, performance problems in microservices architectures are considerably more challenging to troubleshoot than performance problems with monolithic applications. When performance problems arise in monolithic applications, troubleshooting is typically a manageable process because the application is based on a single code. Developers typically discover sources of problems with a monolithic application by reading log messages that record information about the state of an operating system, state of a service, or state of computer hardware at points in time. On the other hand, troubleshooting microservices architectures is considerably more challenging and time consuming. Each service generates a separate file of log messages. As a result, typical microservices architectures can generate millions of log messages each day. Troubleshooting a performance problem with a distributed application often requires teams of developers and software engineers to manually sort through log messages to determine root causes of hardware and software performance problems. However, this process can be prohibitively expensive because of the large volumes of log messages that must be stored and evaluated for a performance problem. Moreover, because microservices are often connected to information or processing performed by other microservices as described above with reference to FIG. 14, a performance problem with one microservice may create a cascade of performance problems with other microservices that are not actually the root cause of the problem. This cascade of problems are recorded in different log files associated with the different microservices. As a result, troubleshooting a performance problem with a distributed application can take days and, in some cases, longer.

Automated computer-implemented systems described herein are directed to collecting, storing, searching, and correlating metrics, log messages, and traces of a distributed application running in a data center. An open telemetry (“OTL”) collector is installed with each microservice of a distributed application. Each OTL collector includes an OTL library and an OTL agent. The OTL library monitors every request sent to the microservice, collects metrics, log messages, and traces within a time interval for the microservice to respond to the request, and adds a common identifier (“common ID”) to the collected metrics, log messages, and spans. The common_ID correlates, or links, the metrics, log messages, and spans that are associated with a user request. An OTL agent is also installed with each microservice of the distributed application. Each OTL agent forwards the metrics. log messages, and traces to a forwarder as described below.

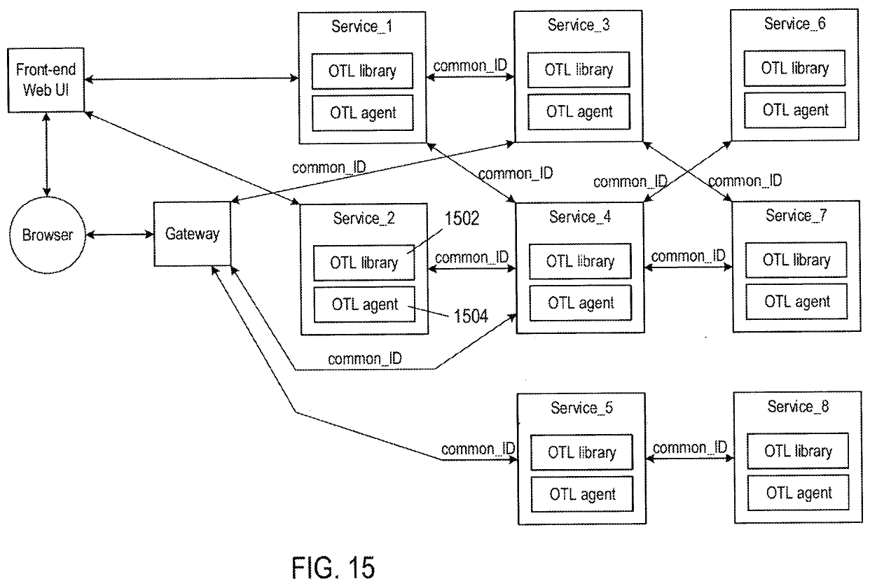

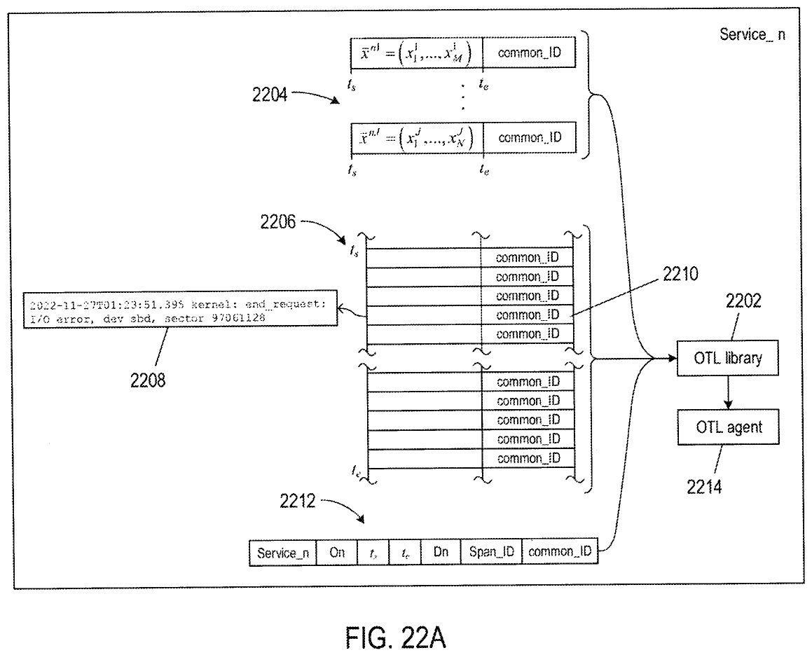

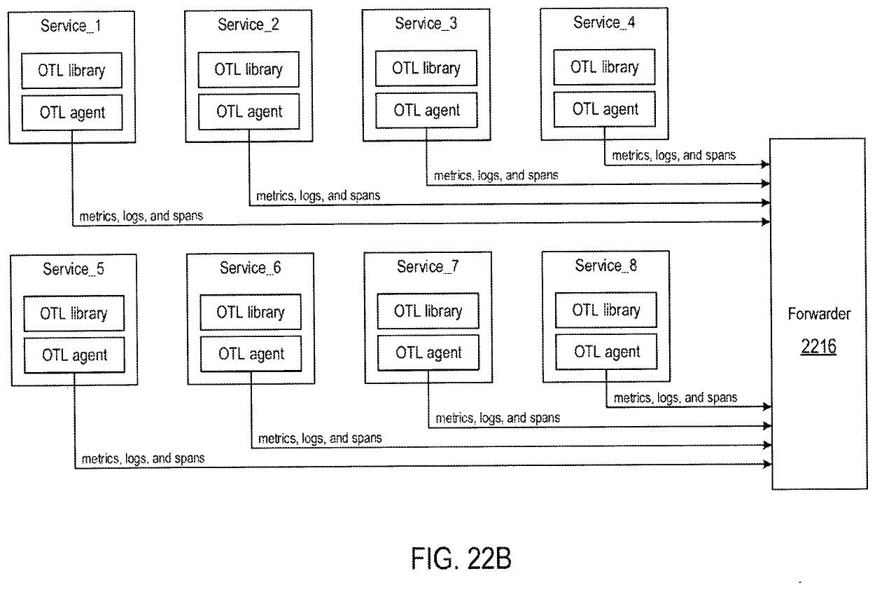

FIG. 15 shows an example of the distributed application described above with reference to FIG. 14. In this example, an OTL library and an OTL agent is installed with each microservice. Each OTL library monitors every request of the corresponding microservice. For example, an OTL library 1502 has been installed with the microservice Service_2. The OTL library 1502 monitors every request of the microservice Service_2 and collects metrics, log messages, and spans associated with operations performed by the microservice Service_2. When a user request for the distributed application is initiated, such as a customer initiating a purchase of goods or services from a vendor, a common identifier (“common ID”) is created by the microservice that receives the request. For example, when a user begins a user request via Service_1 or Service_2, the microservices create a common ID that identifies the user request. The common_ID can an alphanumeric sequence that is used to identify the request and is distributed to the other microservices of the distributed application that execute services performed in completion of the user request. For example, a common ID can be a 16-character alphanumeric sequence, such as “cd8f17b48095 ae3fd.” Each OTL library assigns the common_ID to the metrics, log messages, and spans collected by the OTL library during completion of a microservice. Each OTL agent sends the metrics, log messages, and spans collected by the OTL library to a forwarder as described below with reference to FIGS. 22A-22B. For example, OTL agent 1504 sends the metrics, log messages, and spans collected by the OTL library 1502 to the forwarder.

A stream of metric data is time-series data that is generated by an event source of an object, such as an operating system, a resource, or by a microservice. A stream of metric data is a sequence of time-ordered metric values that are recorded in a data storage device in spaced points in time called “time stamps.” A stream of metric data is simply called a “metric” and is denoted by

$$\vec{x} = {( {x}_{i} )}_{i = 1}^{N} = {( x ( {t}_{i} ) )}_{i = 1}^{N}$$

where
   N is the number of metric values in a sequence of metric values;
   xᵢ=x(tᵢ) is a metric value;
   tᵢ is a time stamp indicating when the metric value was generated in a time interval [t₁, t_{N}];
[symbol] = [symbol] ^{N}; and
   subscript i is a time stamp index i=1, . . . , N.

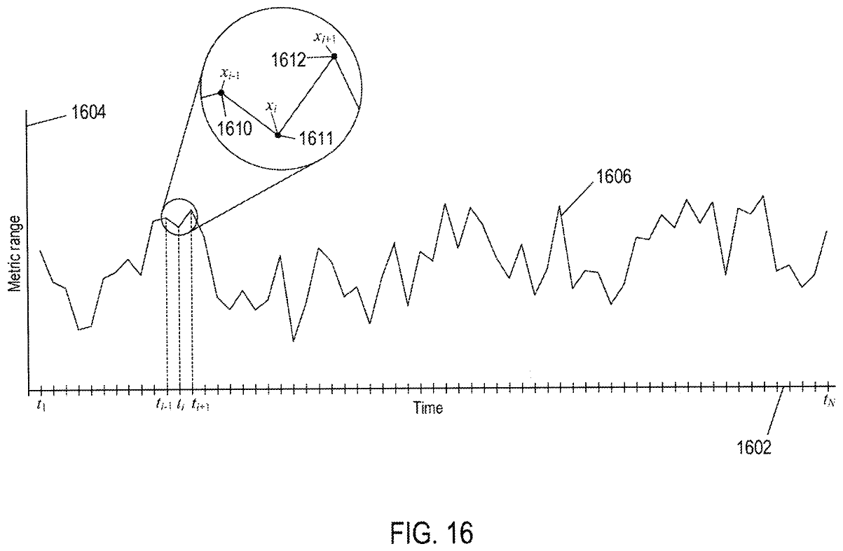

FIG. 16 shows a plot of an example metric. Horizontal axis 1602 represents time. Vertical axis 1604 represents a range of metric values. Curve 1606 represents a metric as time-series data. FIG. 16 includes a magnified view 1608 of three consecutive metric values represented by points. Each point represents an amplitude of the metric at a corresponding time stamp. For example, points 1610-1612 represent consecutive metric values (i.e., amplitudes) xᵢ₋₁, xᵢ, and xᵢ₊₁ recorded in a data-storage device at corresponding time stamps tᵢ₋₁, tᵢ, and tᵢ₊₁. The metrics collected by an OTL library are tagged with a trace ID and sent by the OTL agent to the forwarder in the operations manager 1332.

The example metric in FIG. 16 may represent usage of a physical or virtual resource. For example, the metric may represent CPU usage of a core in a multicore processor of a server computer over time. The metric may represent the amount of virtual memory assigned to a VM over time. The metric may represent network throughput for a server computer. The metric may also represent object performance, such as CPU contention, response time to requests, and wait time for access to a resource of an object. The metric may also be a key performance indicator (“KPIs”) used to monitor the overall health and performance of a microservice. A KPI is a health metric constructed from other metrics. Certain KPIs that do not depend on other metrics can be used to monitor performance of microservices. For example, a KPI for an online shopping application could be the number of shopping carts successfully closed per unit time. A KPI for a website may be response times to customer requests. Other KPIs can be used to monitor performance of various microservices provided by different components of a distributed application. Consider, for example, a distributed application that provides banking services via a bank website or a mobile application (“mobile app”). One microservice provides front-end services that enable users to input banking requests and receive responses to requests via the website or the mobile app. Other components of the distributed application provide back-end services that are executed in virtual objects running on hosts of the data center. These services include processing user banking requests, maintaining data storage, and retrieving user information from data storage. Each of these microservices can be monitored with an error rate KPI and a time spent responding to a request from other microservices.

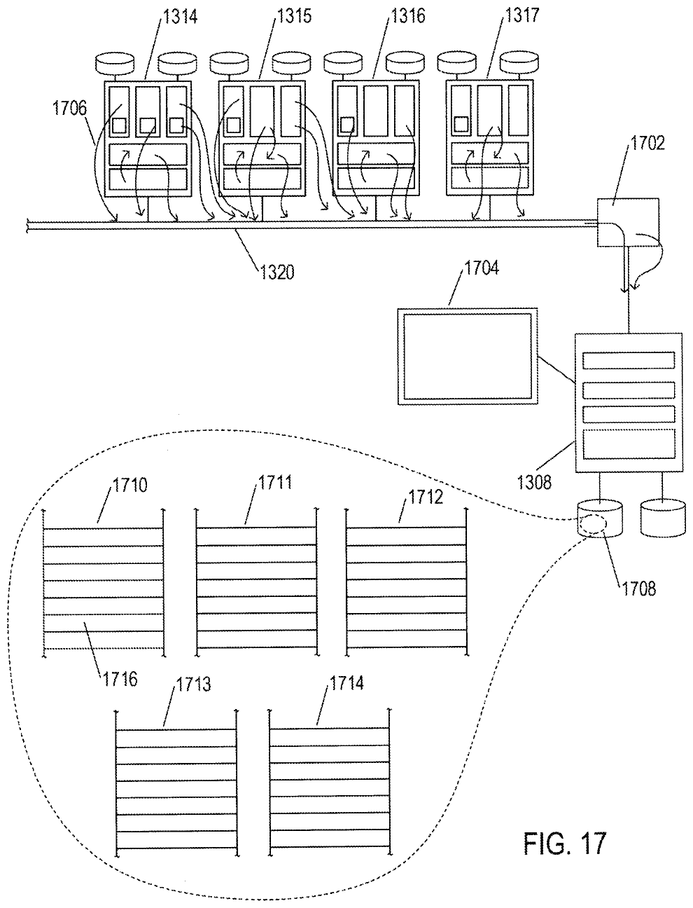

FIG. 17 shows an example of logging log messages in log files. In FIG. 17, computer systems 1314-1317 of the distributed computing system in FIG. 13 are linked together by the electronic communications medium 1320 and additionally linked through a communications bridge/router 1702 to the administration computer system 1308 that includes an administrative console 1704. Each of the computer systems 1314-1317 runs an OTL library and a OTL agent with a corresponding microservice as described above. The OTL agents forward log messages to the operations manager 1332 executing on the administration computer system 1308. As indicated by curved arrows, such as curved arrow 1706, multiple components within each of the discrete computer systems 1314-1317 as well as the communications bridge/router 1702 generate log messages that are forwarded to the operations manager 1332. Log messages may be generated by any event source. Event sources may be, but are not limited to, microservices, operating systems. VMs, guest operating systems, containers, network devices, machine codes, event channels, and other computer programs or processes running on the computer systems 1314-1317, the bridge/router 1702 and any other components of a data center. Log messages may be received by OTL agents at various hierarchical levels within a discrete computer system and then forwarded to the forwarder in the operations manager 1332 executing in the administration computer system 1308. The operations manager 1332 records the log messages in a data storage device or appliance 1708 as log files 1710-1714. Rectangles, such as rectangle 1716, represent individual log messages. Each OTL agent has a configuration that includes a log path and a log parser.

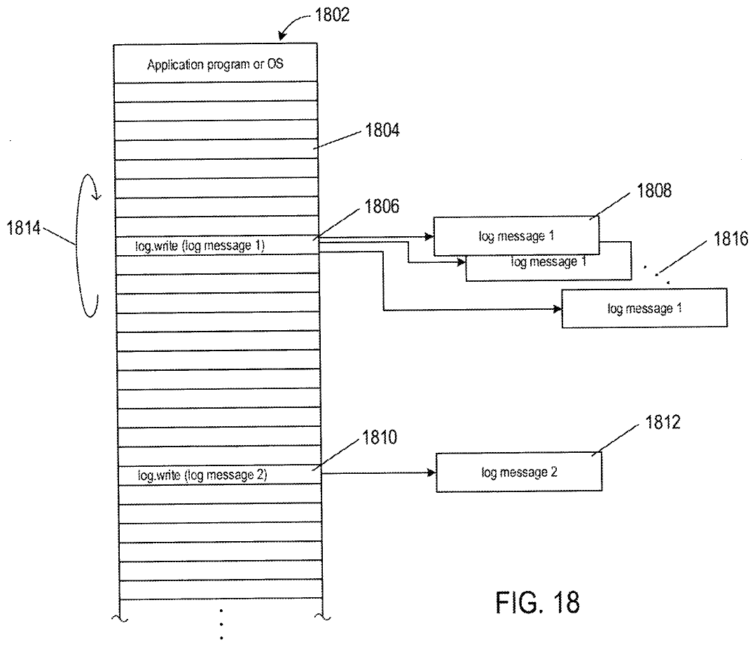

FIG. 18 shows an example source code 1802 of an event source, such as an application, an operating system, a VM, a guest operating system, or any other computer program or machine code that generates log messages. The source code 1802 is just one example of an event source that generates log messages. Rectangles, such as rectangle 1804, represent a definition, a comment, a statement, or a computer instruction that expresses some action to be executed by a computer. The source code 1802 includes log write instructions that generate log messages when certain events predetermined by a developer occur during execution of the source code 1802. For example, source code 1802 includes an example log write instruction 1806 that when executed generates a “log message 1” represented by rectangle 1808, and a second example log write instruction 1810 that when executed generates “log message 2” represented by rectangle 1812. In the example of FIG. 18, the log write instruction 1808 is embedded within a set of computer instructions that are repeatedly executed in a loop 1814. As shown in FIG. 18, the same log message I is repeatedly generated 1816. The same type of log write instructions may also be located in different places throughout the source code, which in turns creates repeats of essentially the same type of log message in the log file.

In FIG. 18, the notation “log.write( )” is a general representation of a log write instruction. In practice, the form of the log write instruction varies for different programming languages. In general, the log write instructions are determined by the developer and unstructured, or semi-structured, and relatively cryptic. For example, log write instructions may include instructions for time stamping the log message and contain a message comprising natural-language words and or phrases as well as various types of text strings that represent file names, path names, and, perhaps various alphanumeric parameters that may identify objects, such as VMs, containers, or virtual network interfaces. In practice, a log write instruction may also include the name of the source of the log message (e.g., name of the application program. operating system and version, server computer, and network device) and may include the name of the log file to which the log message is recorded. Log write instructions may be written in a source code by the developer of an application program or operating system in order to record the state of the application program or operating system at a point in time and to record events that occur while an operating system or application program is executing. For example, a developer may include log write instructions that record informative events including, but are not limited to, identifying startups, shutdowns. I/O operations of applications or devices; errors identifying runtime deviations from normal behavior or unexpected conditions of applications or non-responsive devices; fatal events identifying severe conditions that cause premature termination; and warnings that indicate undesirable or unexpected behaviors that do not rise to the level of errors or fatal events. Problem-related log messages (i.e., log messages indicative of a problem) can be warning log messages, error log messages, and fatal log messages. Informative log messages are indicative of a normal or benign state of an event source.

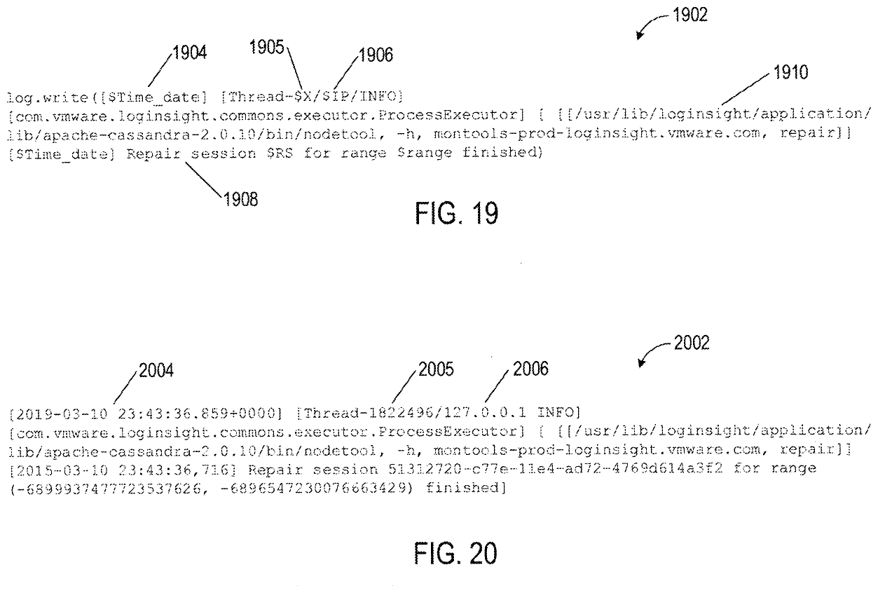

FIG. 19 shows an example of a log write instruction 1902. The log write instruction 1902 includes arguments identified with “$” that are filled at the time the log message is created. For example, the log write instruction 1902 includes a time-stamp argument 1904, a thread number argument 1906, and an internet protocol (“IP”) address argument 1908. The example log write instruction 1902 also includes text strings and natural-language words and phrases that identify the level of importance of the log message and type of event that triggered the log write instruction, such as “Repair session” 1908. The text strings between brackets “[ ]” represent file-system paths, such as path 1910. When the log write instruction 1902 is executed, parameters are assigned to the arguments and the text strings and natural-language words and phrases are stored as a log message of a log file.

FIG. 20 shows an example of a log message 2002 generated by the log write instruction 1902. The arguments of the log write instruction 1902 are assigned numerical parameters that are recorded in the log message 1602 at the time the write instruction is executed. For example, the time stamp 1904, thread 1906, and IP address 1908 arguments of the log write instruction 1902 are assigned corresponding numerical parameters 2004, 2006, and 2008 in the log message 2002. The time stamp 2004 represents the date and time the log message is generated. The text strings and natural-language words and phrases of the log write instruction 1902 also appear unchanged in the log message 2002 and may be used to identify the type of event (e.g., informative, warning, error, or fatal) that occurred during execution of the event source.

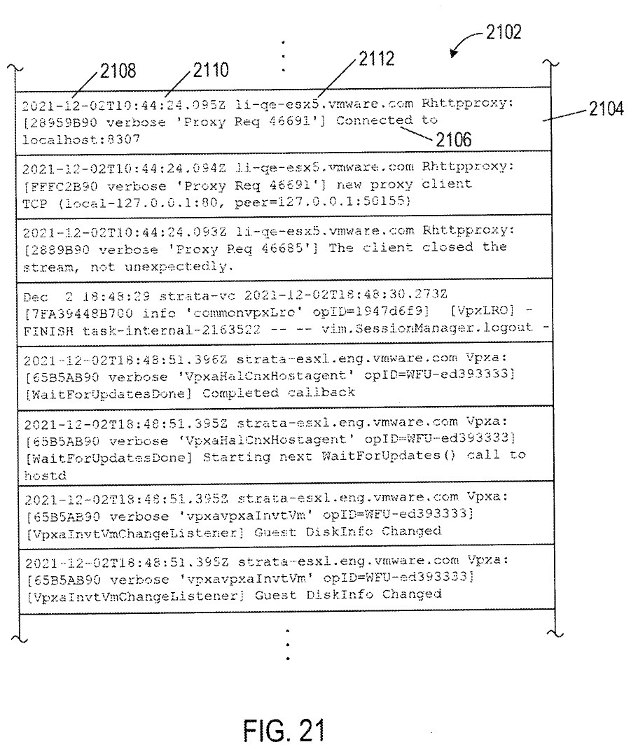

As log messages are received at the log management server from various event sources, the log messages are stored in corresponding log files in the order in which the log messages are received. FIG. 21 shows a small, eight-entry portion of a log file 2102. In FIG. 21, each rectangular cell, such as rectangular cell 2104, of the log file 2102 represents a single stored log message. For example, log message 2104 includes a short natural-language phrase 2106, date 2108 and time 2110 numerical parameters, and an alphanumeric parameter 2112 that identify a particular host computer.

Each OTL library records a span that represents a single operation performed by a microservice. Each OTL library applies a common_ID to spans that correspond to the user request of the same distributed application. Each span records metadata about the operation captured by the span and the service performed by the microservice as represented in the following table:

| Tag | Description |
|---|---|
| Service | Name of the service associated |
| | with the span |
| ParentSpan_ID | Span_ID of the microservice |
| | that requested the Service |
| Span_ID | 16-character unique identifier |
| Common_ID | 16-character unique identifier |
| Start time | Start time stamp of the service |
| End time | End time stamp of the service |
| Duration | Duration of the span |
| | End time - Start time) |

Each OTL agent forwards the span to the forwarder when the distributed application has completed execution of the user request.

FIG. 22A shows an example of metrics, log messages, and a span collected by an OTL library 2202 of a microservice Service_n of a distributed application. The microservice Service_n completes a service request in a time interval [tₛ, tₑ], where tₛ denotes the start time of the request and tₑ denotes the end time when the request is completed. The service request may come from another microservice of the distribute application. For example, in FIG. 15, microservice Service_4 may send a request for execution of service to be performed by microservice Service_6. The OTL library 2202 running in the microservice Service_n collects metrics 2204 [symbol] ^{nj} with metric values recorded in the time interval [tₛ, tₑ], where superscript n identifies the microservice and subscript j=1, . . . J is a metrics index. For example, the J metrics may include CPU usage, virtual CPU usage, memory usage, virtual memory usage, CPU contention, response time, wait time for access to resources, and at least one KPI recorded in the time interval [tₛ, tₑ]. Each of the metrics is labeled with the common_ID associated with the user request. The OTL library 2202 collects log messages 2206 generated by event sources associated with the microservice Service_n with time stamps in the time interval [tₛ, tₑ]. For example, log message 2208 is labeled with the common_ID 3210. The OTL library 2202 records a span 2212 composed of metadata of the microservice Service_n. The span includes the name of the microservice Service_n, the operation performed by the microservice denoted by On, the start time tₛ, end time tₑ, duration of the microservice denoted by Dn, the common_ID and a unique span identifier (“span_ID”) that uniquely identifies the span. For example, the span ID can be a 16-character alphanumeric sequence generated by the OTL library 2202. The OTL library 2202 tags the metrics 3204, the log messages 2206, and the span 2212 with the common_ID and sends the tagged metrics, log messages, and the span to the OTL agent 2214. Each of the OTL agents sends tagged metrics, log messages, and spans collected by corresponding OTL libraries to a forwarder 2216 as shown in FIG. 22B.

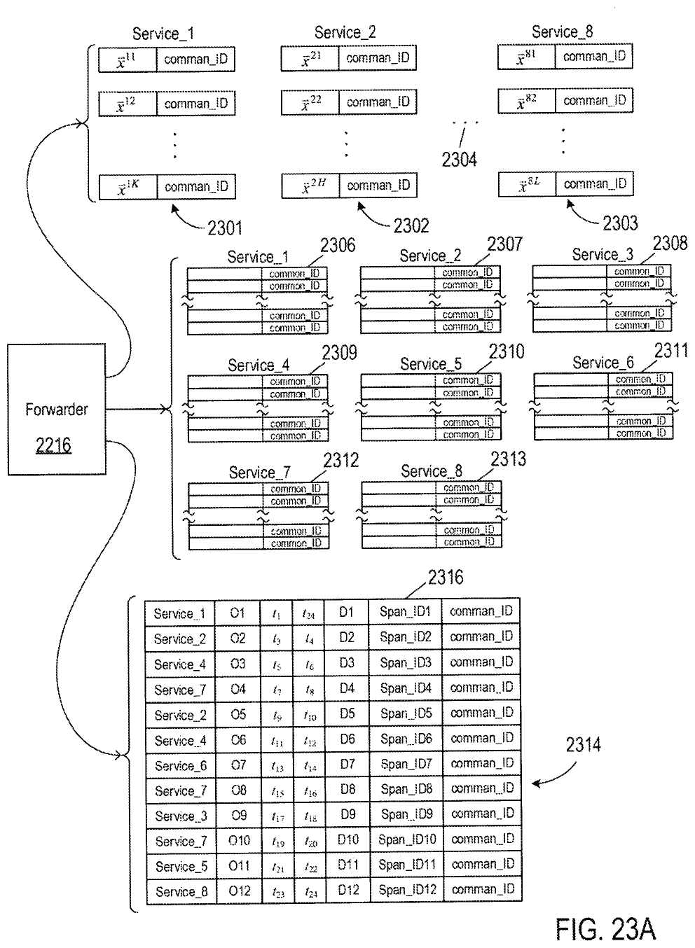

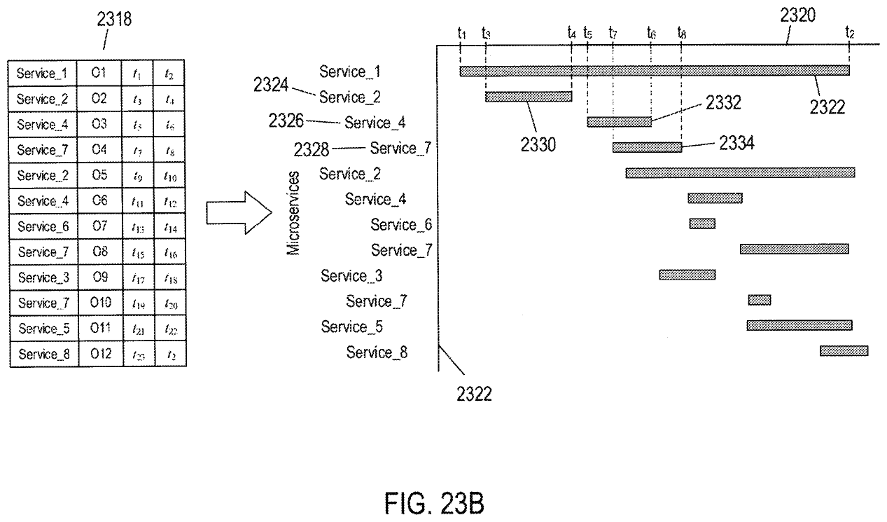

FIG. 23A shows an example of metrics, log messages, and spans received by the forwarder 2216 from the OTL agents of the eight microservices Service_n, where n=1, . . . , 8, that perform microservices associated with a distributed application. The forwarder 2216 receives metrics 2301 from the OTL agent of the microservice Service_1, metrics 2302 from the OTL agent of the microservice Service_2, and metrics 2303 from the OTL agent of the microservice Service_8. For example, metrics [symbol] ¹¹, . . . , [symbol] ^{1K} represent K metrics recorded for the microservice Service_1 during execution of the Service_1. The metrics include CPU usage, virtual CPU usage, memory usage, virtual memory usage, CPU contention, response time, wait time for access to resources, and at least one KPI for the microservice Service_1. Note that each of the metrics is tagged with the common_ID. Ellipsis 2304 represents metrics (not shown) received from the OTL agents of the microservices Service_3 through Service_7. The forwarder 2216 receives eight separate sets of log messages 2306-2313 recorded for each of the eight microservices. For example, the set of log messages 2307 contains the log messages generated by event sources associated with the microservice Service_2 during execution of the microservice Service_2. Note that each of the log messages is tagged with the common_ID. The forwarder 2216 aggregates the spans received from the OTL agents to form a trace that records an execution path of the operations performed by the microservices from beginning to end in completion of the user request. Table 2314 represents collection of the twelve example spans received by the forwarder 2216 from the OTL agents of the eight microservices generated during execution of the distributed application. Certain services are executed more than once. For example, microservice Service_4 is executed three different times to perform operations O₄, O₆, and O₁₀ with corresponding durations D4, D6, and D10. Note that each span has the same common_ID but each span has a unique span identifier listed in column 2316. The metrics, log messages, and spans with the same common_ID correspond to same user request.

The forwarder 2216 aggregates spans with the same common_ID into a trace that reveals how processing of a user request flows through the microservices of the distributed application. A trace is composed of one or more spans. Each span represents one microservice in an execution path through the microservices. In other words, the trace represents the path of services performed by microservices of the distributed application to complete the user request. For example, a credit check could be a span in a trace that represents services performed by microservices of an application that processes an online order for goods or services. Spans can create multiple child spans, and each child span has exactly one parent span.

FIG. 23B shows an example trace formed from the twelve spans in the table 2314 of FIG. 23A. Table 2318 displays the microservices and start and end times of the microservices displayed in table 2314 in FIG. 23A. Horizontal line 2320 represents a time axis. The microservices of the application are listed to the left of vertical line 2322. Indented microservices indicate microservices that perform a requested service by a preceding microservice. For example, microservice Service_2 2324 request a service from microservice Service_4 2326, which requests a service microservice Service_7 2328. Each bar represents the duration of a span, which is an amount of time (i.e., duration) spent executing one of the microservices. For example, bar 2322 represents the duration of the Service_1, such as the time spent displaying information and receiving commands from a user via a browser. Bar 2330 represents the duration of the operation O2 performed by microservice Service_2. Bar 2332 represents the duration of the operation O3 performed by microservice Service_4 in response to the request from microservice Service_2. Bar 2334 represents the duration of the operation O4 performed by microservice Service_7 in response to the request from microservice Service_4.

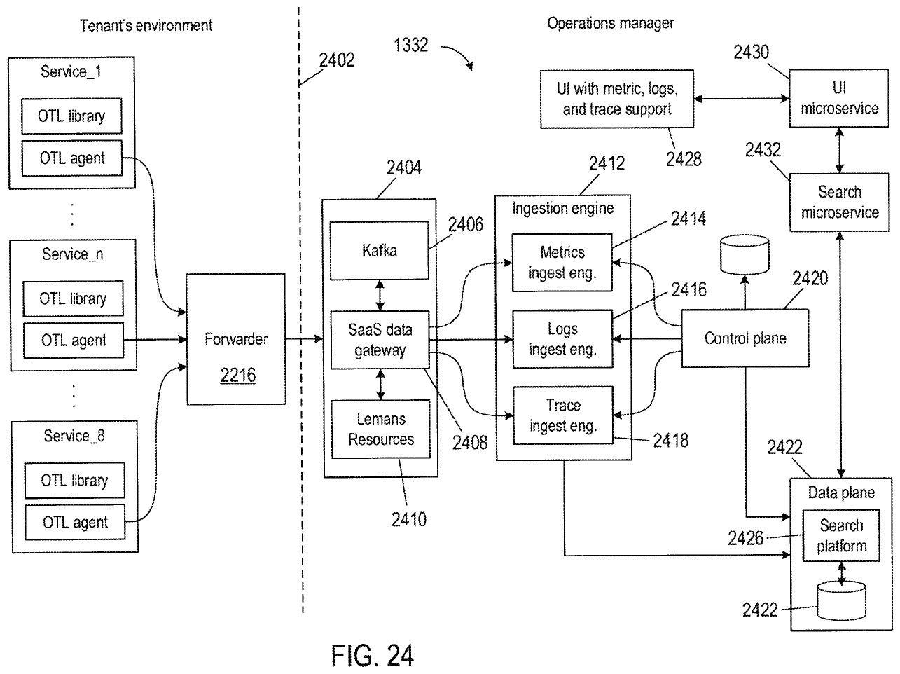

FIG. 24 shows an example architecture of the operations manager 1332. Dashed line 2402 separates the tenant's environment from the architecture of the operations manager 1332. The tenant's environment comprises the microservices Service_n, where n=1, . . . ,8, of the distributed application and the forwarder 2216. The microservices send metrics, log messages, and span to the forwarder 2216 as descried above. The operations manager 1332 includes a data gateway 2404 that is composed of Kafka 2406, a software as a service (“SaaS”) gateway 2408, and lemans resources 2410. The SaaS gateway 2408 establishes a trusted connection with the forwarder 2216. In other words, the SaaS gateway 2408 performs authentication of the forwarder 2216. When the forwarder 2216 has been established that the forwarder 2216 is a trusted system, the SaaS gateway 2408 accepts receipt of the metrics, log messages, and spans from the forwarder 2216. Kafka 2406 establishes a real-time streaming data pipeline between the forwarder 2216 and the SaaS gateway 2408, Kafka 2406 buffers the metrics, log messages, and spans in temporary storage. The SaaS gateway 2408 aggregates the spans that are associated with the user request. Lemans resources 2410 stores the configurations of the metrics, log messages, and traces. The SaaS gateway 2408 forwards the metrics, log messages, and traces to an operations ingestion 2412. The operations ingestion 2412 separates the metrics, log messages, and traces and sends the metrics to a metric ingestion engine 2414, sends the log messages to a log ingestion engine 2416, and sends the trace to a trace ingestion engine 2418.

The trace ingestion engine 2418 executes a series of transformer chains for data cleansing to form traces. In other words, the trace ingestion engine 2418 extracts metadata from spans of the trace; discards empty or partial traces; and adds addition metadata, such as tenant information, usage reports, and time stamps. The trace ingestion engine 2418 applies a trace identifier (“Trace_ID”) tag to the aggregated spans, such as a 16-character alphanumeric sequence. A trace is output from the transformation chain.

A control plane 2420 directs storage of the metrics, log messages, and trace with the same common_ID to be stored in the data plane 2422. The data plane 2422 executes operations that store the metrics, log messages, and trace in a database 2424. The data plane 2422 includes a search platform 2426 that executes searches of the database 2424 for metrics, log messages, and traces with a common_ID.

The operations manager 1332 displays a UI 2428 in a display device that contains the metrics, the log messages, and the trace associated with each user request of the distributed application in a display device. A user can submit a search request via the UI to view metrics, log messages, and a trace associated with a particular user request. UI microservice 2430 receives instructions via the UI 2428 to view metrics, log messages, and a trace for the search request. Search microservice 2432 receives the search request from the UI microservice 2430 and instructs the search platform 2416 to retrieve the metrics, log messages, and the associated with the search request. The search platform 2426 retrieves the metrics, log messages, and the trace associated with the request from the database 2424. The search microservice 2432 forwards the search results to the UI microservice 2430, which displays the results in the UI 2428.

The UI aids tenants with visualization of distributed application performance and service failures in real time, which saves a significant amount of debugging time. The user is able to visually identify which microservices of a distributed application are slower by simply looking at the durations of spans comprising a trace in the UI. The UI can be zoomed in or expanded at every trace level to identify issues in the application requests. For every trace, the operations manager 1332 collects structured data about the complete runtime environment. The structured data enables users to identify version upgrades, kind of failures, and enables tracking of compatibility issues.

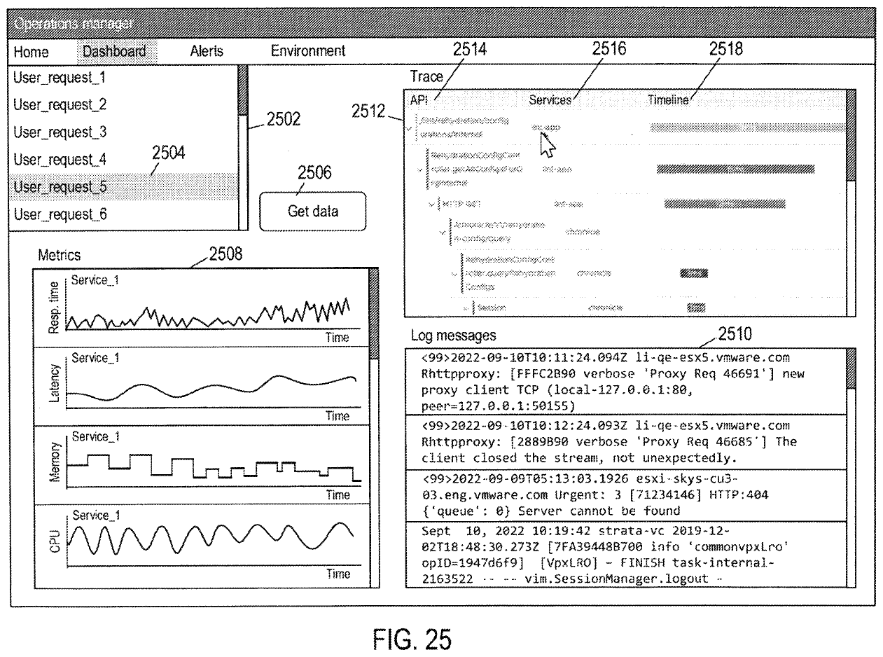

FIG. 25A shows an example UI that enable a user to display metrics, log messages, and a trace associated with each user request of the distributed application. The UI includes a window 2502 that displays each user request. In this example, a user has selected user_request_5 2504. In this example, the user has clicked on a button 2506. The UI microservice 2430 and search microservice 2432 retrieve the metrics, log messages, and a trace associated with the user selection 2504 from the database 2422. The UI includes a metrics window 2508 that displays the metrics associated with each of the microservices of the distributed application executed in responding to the user selection 2504. In this example, window 2508 displays, response time, latency, memory, and CPU usages for Service_1 of the distributed application. The UI includes a log messages window 2510 that displays the log messages generated by event sources associated with each of the microservices of the distributed application. The UI includes a trace window 2512 that displays the names of the API's that call the microservices in a column 2514, the names of the microservices of the distributed application in column 2516, and the duration of each microservice in column 2518. Note that a user can visually identify the durations of the microservices of the distributed application in column 2518. In this example, a user clicks on microservice 2520, which opens a display of the structured data associated with the microservice “lint-app” in FIG. 25B. The operations manager 1332 has collected structured data about the complete runtime environment of the “lint-app.” The example structured data displayed in FIG. 25B help the users to figure out version upgrade of the “lint-app.” kind of failures associated with the “lint-app.” and enables tracking of compatibility issues.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for monitoring execution of a distributed application running in a data center, the system comprising:
a forwarder that collects metrics, log messages, and spans output from microservices of the distributed application for a user request received by the distributed application;
an ingestion engine that receives the metrics, the log messages, and the spans output from the forwarder, forms a trace from the spans, and stores the metrics, the log messages, and the trace in a database; and
a user interface (“UI”) that displays the metrics, the log messages, and the trace in response to a user selection of the user request via the UI.

2. The system of claim 1 wherein each of the microservices of the distributed application comprises an open telemetry (“OTL”) collector that collects the metrics from event sources of the microservice, the log messages from events sources of the microservice, and generates one or more spans, each span representing a single operation performed by one of the microservices.

3. The system of claim 2 wherein the OTL collector comprises:
an OTL library that collects the metrics, the log messages, and generates the one or more spans associated with a service performed by the microservice and tags the metrics, the log messages, and the one or more spans with a common identifier; and
an OTL agent that sends the metrics, the log messages, and the spans collected by the OTL library to the forwarder.

4. The system of claim 1 wherein the ingestion engine comprises:
a metrics ingestion engine that receives the metrics and stores the metrics with a common identifier in the database;
a log messages ingestion engine that receives the log messages and stores the log messages with the common identifier in the database; and
a trace ingestion engine that receives the spans, forms the trace from the spans, tags the trace with a trace identifier, and stores the trace with the common identifier and the trace identifier in the database.

5. The system of claim 1 further comprising:
a UI microservice that receives the user selection from the UI; and
a search microservice that receives instructions from the UI microservice and instructs a search platform to retrieve the metrics, the log messages, and the trace from the database.

6. A computer system for monitoring execution of a distributed application running in a data center, the system comprising:
one or more processors;
one or more data-storage devices; and
machine-readable instructions stored in the one or more data-storage devices that when executed using the one or more processors controls the system to perform the operations comprising:
collecting metrics, log messages, and spans output from microservices of the distributed application for a user request received by the distributed application;
forming a trace from the spans;
storing the metrics, the log messages, and the trace with a common identifier in a database of the one or more data-storage device; and
displaying a user interface (“UI”) in a display device the metrics, the log messages, and the trace in response to receiving a user selection of the user request via the UI.

7. The system of claim 6 wherein collecting metrics, log messages, and spans output from microservices of the distributed application each of the microservices of the distributed application comprises for each microservice, collecting the metrics from event sources of the microservice, collecting the log messages from the microservice, and generating one or more spans, each span representing a single operation performed by the microservice.

8. The system of claim 7 wherein collecting metrics, log messages, and spans output from microservices of the distributed application each of the microservices comprises:
collecting the metrics, the log messages, and generates the one or more spans associated with a service performed by the microservice and tags the metrics, the log messages, and the one or more spans with a common identifier; and
sending the metrics, the log messages, and the spans to the forwarder.

9. Apparatus for monitoring execution of a distributed application running in a data center, the apparatus comprising:
a forwarder for collecting metrics, log messages, and spans output from microservices of the distributed application for a user request received by the distributed application;
an ingestion engine for receiving the metrics, the log messages, and the spans output from the forwarder, forming a trace from the spans, and storing the metrics, the log messages, and the trace in a database; and
a user interface (“UI”) for displaying the metrics, the log messages, and the trace in response to a user selection of the user request via the UI.

10. The apparatus of claim 9 wherein each of the microservices of the distributed application comprises an open telemetry (“OTL”) collector for collecting the metrics from event sources of the microservice, collecting the log messages from events sources of the microservice, and generating one or more spans, each span representing a single operation performed by one of the microservices.

11. The apparatus of claim 10 wherein the OTL collector comprises:
an OTL library for collecting the metrics, the log messages, and generates the one or more spans associated with a service performed by the microservice and tags the metrics, the log messages, and the one or more spans with a common identifier; and
an OTL agent for sending the metrics, the log messages, and the spans collected by the OTL library to the forwarder.

12. The apparatus of claim 9 wherein the ingestion engine comprises:
a metrics ingestion engine for receiving the metrics and storing the metrics with a common identifier in the database;
a log messages ingestion engine for receiving the log messages and storing the log messages with the common identifier in the database; and
a trace ingestion engine for receiving the spans, forming the trace from the spans, tagging the trace with a trace identifier, and storing the trace with the common identifier and the trace identifier in the database.

13. The apparatus of claim 9 further comprising:
a UI microservice for receiving the user selection from the UI; and
a search microservice for receiving instructions from the UI microservice and instructing a search platform to retrieve the metrics, the log messages, and the trace from the database.
